(19) United States
(12) Patent Application Publication
(10) Pub. No.: US 2003/0163404 A1
(43) Pub. Date: Aug. 28, 2003

(54) Method of evaluating security trading capacity

(76) Inventors: Kenneth Hu, San Gabriel, CA (US); Tzy-Kang Hu, San Gabriel, CA (US)

Correspondence Address: RAYMOND Y. CHAN, 1050 OAKDALE LANE, ARCADIA, CA, 91006, US

(21) Appl. No.: 10/080,855

(22) Filed: Feb. 22, 2002

(51) Int. Cl. G06F 17/60

(52) U.S. Cl. 705/36

(57) ABSTRACT

A method of evaluating stock trading capacity includes the steps of providing a personal investment portfolio having a predetermined market value, setting aside a portion of an equity to form a cash reserve from the investment portfolio wherein the cash reserve serves as a cash portion of a future asset allocation, inputting a trade order of desired amount by a user wherein the trade order must include a security to be traded and a trading price when either a fixed price is desired or a price quote is unable to be retrieved automatically, producing a security balance by computing the trade order according to either a specified quantity or an amount of fund to be committed, and evaluating a cost of the trade order with respect to a disposable cash.

### BACKGROUND OF THE PRESENT INVENTION

1. Field of Invention

The present invention relates to a security trading activity, and more particularly to a method of evaluating security trading capacity, which allows one to effectively manage the portfolio during the stock trading activity, so as to minimize the risk thereof.

2. Description of Related Arts

Tradable security includes bonds, mutual funds, stocks, options, and etc. During security trading activity, traders always desire to buy the securities in the lowest prices and sell them in the highest prices.

Due to the advent of information technology, today the stock and security information, such as security quotes, is vastly available through the mass communications such as television, radio, newspaper, or Internet. Therefore, the traders are able to monitor the securities market and buy and sell stocks and other securities easily. Especially through the Internet, the traders can get access to literally thousands of investment services, publications, newsletters, and discussion groups which are just a mouse click away. Therefore, Internet traders continue to grow rapidly.

However, even though the security quotes are readily available, while the traders may know how much they are willing to invest in particular stocks or securities, they still need to perform some simple mathematics to calculate how many shares or units they can afford before the orders or trades can be placed. Especially when the traders need to sell the holding securities and buy another securities for their portfolios, they must get the prices for all the desired securities to calculate how many shares or units of the holding securities must be sold in order to have enough cash or fund to buy the intended securities. However, in the volatile market, the prices they used to calculate might already be distant from the real market prices. Thus, errors may occur if the calculation results, the data deducted from the market prices which might already become outdated in a fast changing market when applied, are later used for placing trades. I particular, it may result in exceeding their purchasing power. A delay of timing may cause a trade to be placed at an inopportune moment.

Moreover, the price of any tradable security may not be an exact integer. Mostly, securities quotes are decimalized, so that the traders must be carefully calculate the shares or units of the security that they can afford to buy and sell without exceeding their purchasing power. Sometimes, the decimal fraction of the price of the security may cause the failure of the purchasing plan of the trader, especially when a large amount of shares of the intended security will be purchased. It is worth to mention that the sequences for the trader to sell the holding security first and then buy the intended security or to buy the intended security and then sell the holding security can lead to have different results. In other words, the first trade of the security will directly affect the next trade of the security.

When a security has been bought outright, it is called a “long” position. When the investors “long” certain securities, they are expecting the prices to increase. Therefore, buying low and selling high, they can make a profit. However, when a security's price is speculated to fall, an investor may choose to borrow the shares from the securities firm, sell the shares at a high price first, and purchase them and return them back at a lower price later. This is called “Selling Short”. The result is a short position. When a short position is included in the portfolio, its market value is deducted from the portfolio's equity. Continuing from the previous example, if the user is 100 shares short of a particular stock with the present market price of $20 per shares, the final equity is counted by $10,000−100×$20=$8,000. When a short position is being bought back, it is call a “Cover” transaction. However, some securities firms do not require the customers to distinguish “Sell Short” from “Sell”, nor “Cover” from “Buy”.

To sell short, an investor must first opens a margin account with the securities firm. A margin account is an account that allows the account owner to sell short and to borrow money against the net equity of his/her account for purchasing additional securities and/or for withdraw as cash. A margin account may consist of three sub accounts: Cash sub account, Long Margin sub account and Short sub account. A Short sub account may contain an additional sub-sub account, called “Credit”, wherein all the short sell proceeds and/or margin requirements are deposited whenever a short position is established.

It is worth to mention that, a brokerage cash account is an account from which the account owner is not permitted to borrow money from the securities firm, therefore both trading on margin and selling short are disallowed. A cash “sub” account is a sub account of a Margin account wherein the cash, the cash equivalent and all the non-marginable securities are held.

When purchasing on margin, that is borrowing money to help to pay for the purchase, the portion of the purchase price an investor must pay is called the margin requirement. The remainder, or the unpaid portion, is the amount borrowed from the securities firm. For each marginable security held in long margin sub account, there will be two margin requirements. The first one is the Initial Margin Requirement, which dictates the percentage of the purchase price that the investor must deposit when purchasing. The second is the Maintenance Requirement, which is the minimum amount of equity, in percentage, that must be maintained in the margin account. For instance, if the long market value of securities held in a margin account is $10,000, the debit balance is $8,000. The equity is $2,000. If the maintenance requirement is 25%, or $2,500 there will be a $500 shortfall. To make up the difference, the account owner can either deposit additional cash, liquidates the position, or deposit additional fully paid marginable securities. For short positions, there is another set, both the initial and the maintenance, of margin requirements. It is worth to mention that, in addition to meet both the initial and maintenance margin requirements, a new margin account is also required to have at least a minimum amount of equity before the initial transaction can take place. Not all the securities are marginable. If not, 100% of the purchase price must be paid in full. All the securities kept in a Cash account or Cash sub account are not marginable. Therefore if a marginable security is held in a cash “sub” account, it too becomes non-marginable.

Once the margin requirements are met, the excess in equity can be used as additional purchasing power and short selling power. For instance, if a margin account has a cash balance of $0, a long position of $10,000, and a short position of $3,000, then the equity will be $7,000+$10,000−$3,000. If the total margin requirement for the long position is 25% or $2,500=$10,000×25%, and the margin requirement for the short position is 30% or $900=$3,000×30%, then the total margin requirements is $3,400=$2,500+$900. The excess in equity is then calculated as Equity−Margin Requirement, or $2,600=$7,000−$3,400. The excess equity, or $2,600, can be used to purchase additional securities. For a brokerage Cash account, the cash balance can be seen as the account owner's buying power. Yet for a margin account, as seen from the example where the cash balance is $0, but $2,600 can still be disposed at will, it is not the cash balance, but the excess in equity dictates the true buying power.

### SUMMARY OF THE PRESENT INVENTION

A main object of the present invention is to provide a method of evaluating security trading capacity, which allows one to effectively manage the portfolio during the stock trading activity. An investor is able to customizing a personal investment portfolio that includes the cash asset and all the tradable securities. According to the investment portfolio, the investor can supervise the investment plan before performing the security trading activity.

Another object of the present invention is to provide a method of evaluating security trading capacity, wherein the investor is able to preset the cash reserve in the personal investment portfolio for immediately determining the purchasing power, in such a manner that the investor is able to make a quick decision of how much he or she can trade without exceeding his or her purchasing power.

Another object of the present invention is to provide a method of evaluating security trading capacity, wherein the investor is able to create a hypothetical portfolio from the personal investment portfolio on a ‘spreadsheet format’ to mimic the actual security trading activity. Therefore, the investor is able to easily preview and monitor the securities quotes from the hypothetical portfolio.

Another object of the present invention is to provide a method of evaluating security trading capacity, which is a convenient tool for the security investors to allocate their portfolios, so as to effectively invest their capital in the security markets to minimize the risk during the security trading activity.

Another object of the present invention is to provide a method of evaluating security trading capacity, wherein the market value and the equity, or the net worth, of the personal investment portfolio can be updated in real time or periodically, so that all the intended trades will be automatically recalculated to reflect the price changes. Therefore, the investor is able to more accurately invest the capital in the stock market.

Another object of the present invention is to provide a method of evaluating security trading capacity, which allows one to precisely calculate the hypothetical equity, such that the investor is able to eliminate the complex manual calculation and reduce the errors made during calculation.

Accordingly, in order to accomplish the above objects, the present invention provides a method of evaluating security trading capacity, which comprises the steps of:

(a) providing a personal investment portfolio having a predetermined market value;

(b) setting aside a portion of an equity to form a cash reserve from the investment portfolio wherein the cash reserve serves as a cash portion of a future asset allocation or portfolio allocation as well as a conservation of borrowing power when a borrowing is allowed so as to provide a more conservation strategy when investing aggressively;

(c) inputting a trade order of desired amount by a user wherein the trade order must include a security to be traded and a trading price when either a fixed price is desired or a price quote cannot be retrieved automatically;

(d) producing a security balance by computing the trade order according to either a specified quantity or an amount of fund to be committed; and

(e) evaluating a cost of the trade order within a disposable cash amount.

### BRIEF DESCRIPTION OF THE DRAWINGS

FIG. 1 is a flow chart of a method of evaluating security trading capacity according to a preferred embodiment of the present invention.

FIG. 2 is a first sub-flow chart of the method of evaluating security trading capacity according to the above preferred embodiment of the present invention.

FIG. 3 is a second sub-flow chart of the method of evaluating security trading capacity according to the above preferred embodiment of the present invention.

FIG. 4 is a third sub-flow chart of the method of evaluating security trading capacity according to the above preferred embodiment of the present invention.

FIG. 5 is a fourth sub-flow chart of the method of evaluating security trading capacity according to the above preferred embodiment of the present invention.

FIG. 6 illustrates an alternative mode of the method of evaluating stock trading capacity according to the above preferred embodiment of the present invention.

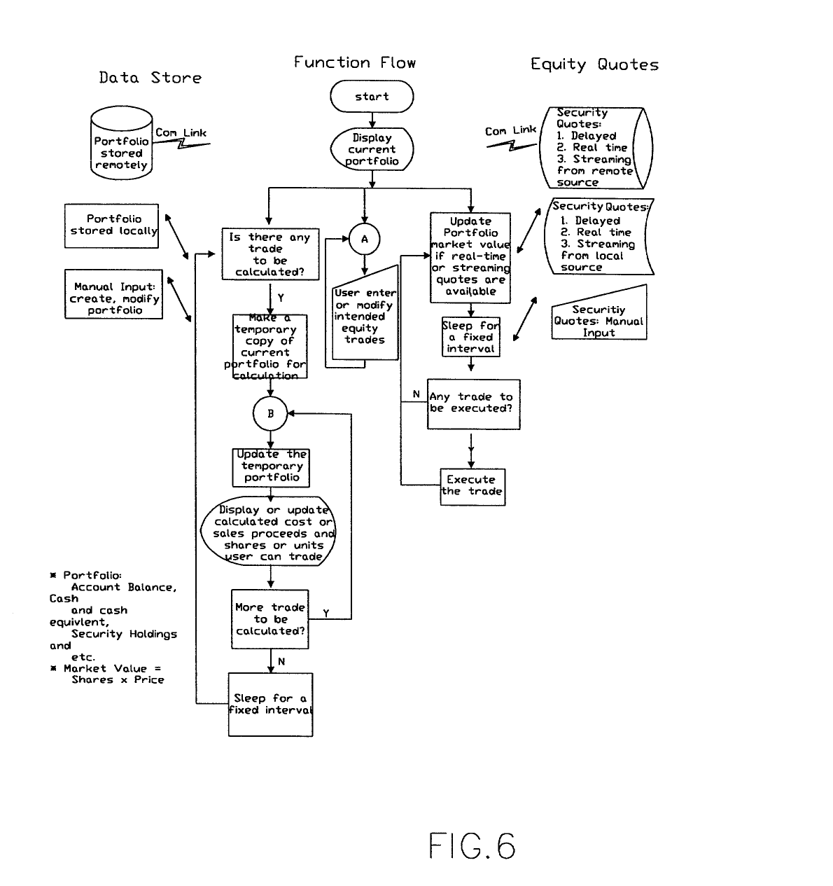

### DETAILED DESCRIPTION OF THE PREFERRED EMBODIMENT

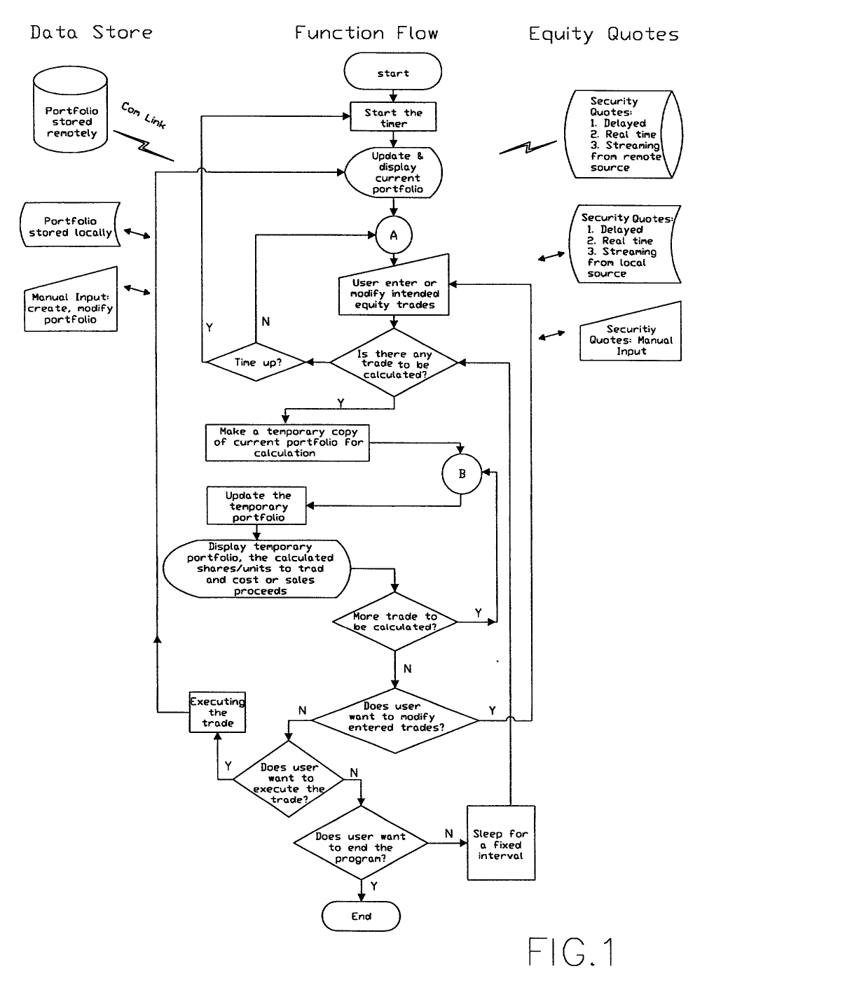

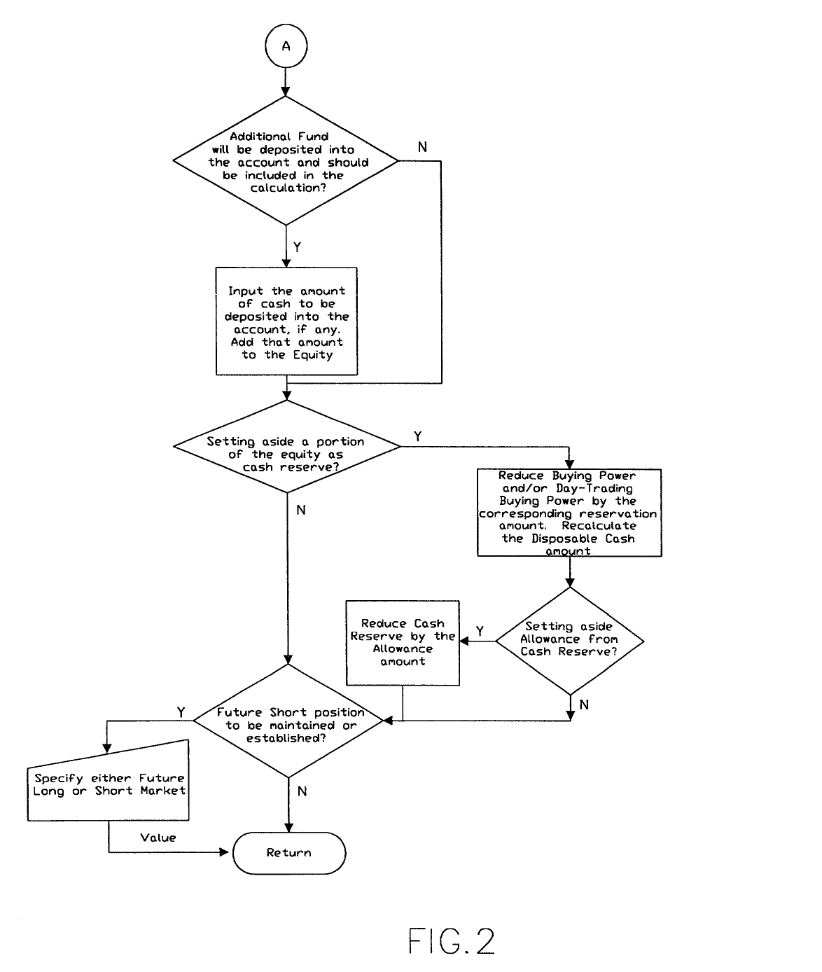

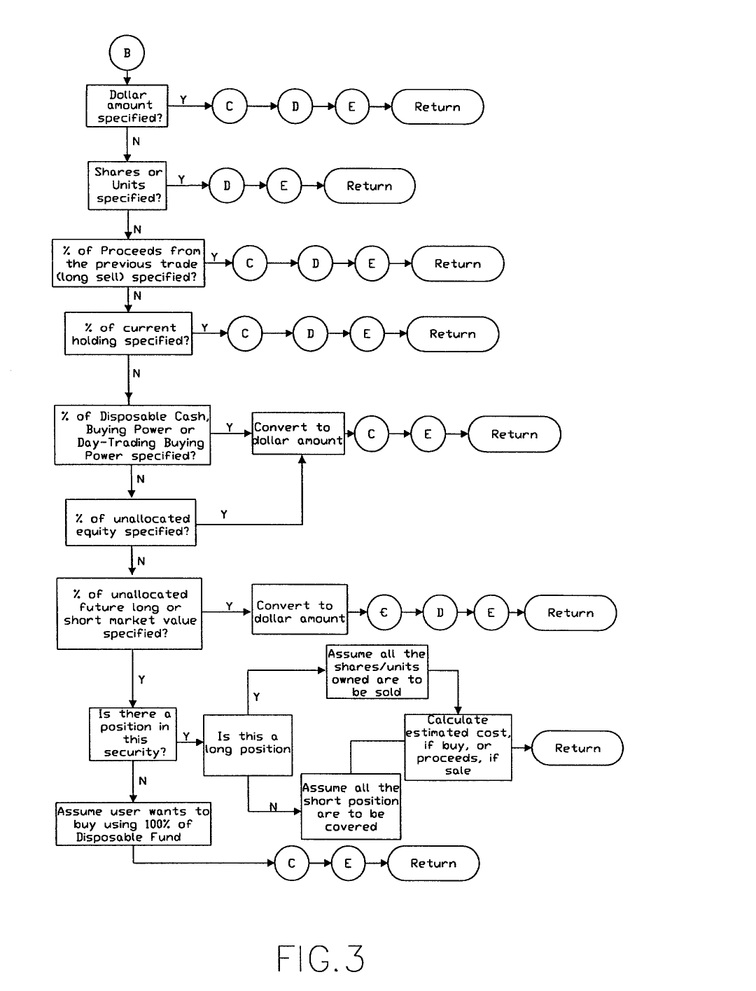

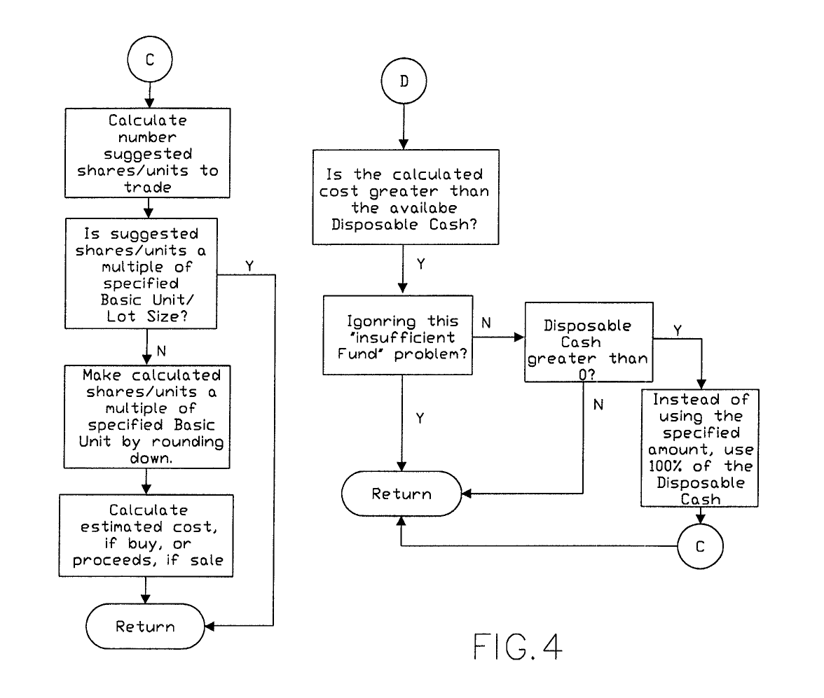

Referring to FIGS. 1 to 5 of the drawings, a method of evaluating security trading capacity according to a preferred embodiment of the present invention is illustrated. The method of evaluating security trading capacity generally comprises the following steps.

(1) Provide a personal investment portfolio having a predetermined market value.

(2) Set aside a portion of an equity to form a cash reserve from the investment portfolio wherein the cash reserve serves as a cash portion of a future asset allocation and a conservation of borrowing power when a borrowing is allowed for a more conservative strategy when investing aggressively, wherein said equity minus said cash reserve forms a disposable cash.

(3) Input a trade order of desired amount by a user wherein the trade order must include a security to be traded and a trading price when either a fixed price is desired or a price quote is unable to be retrieved automatically.

(4) Produce a security balance by computing the trade order according to either a specified quantity or an amount of fund to be committed.

(5) Evaluate a cost of the trade order with respect to said disposable cash.

According to the preferred embodiment, the investment portfolio, in the step (1), can be stored and saved in a central site, which can be owned and operated by an entity, can be an Internet website available for users and/or subscribers to remotely enter anytime and anywhere through an electronic communication system. However, the personal investment portfolio can also be locally stored in an electronic computing device, such as a personal computer, such that the user is able to access the personal investment portfolio at home or office without using any Internet service provider.

The personal investment portfolio may include a predetermined amount of cash and all the tradable securities such as stocks, mutual funds, options or bonds wherein the net equity of the personal investment portfolio is calculated by summing of the value of the cash, debt, credit, and the value of all the tradable securities and then subtracting the value of all the short holdings. The value of the tradable securities is determined by multiplying the shares/units of the tradable securities owned with the market prices at the present time. For example, when the user has two hundreds shares of stock with the present market price of $30 per share, the market value of the personal investment portfolio is counted by $6000=$30×200.

Alternatively, a user can choose to use a different set of quotes, for example, the previous closing prices or the last open prices, for calculating the market values and all the data deducted from such market values for all the positions established prior to the current trading day. This will allow the market value of the personal investment portfolio and all the data deducted from such value to remain constant throughout the entire trading day. This may also be necessary if required by the securities firm. However, for planned trades and new positions established on the current trading day, real time market quotes are preferred to reflect the closest market values possible.

The personal investment portfolio is preferred recorded and displayed in a spreadsheet format on a screen wherein the user information such as the user' name and/or account information such as account number should be shown in the personal investment portfolio in such a manner that when the user access the personal investment portfolio, all necessary information will be indicated for the user.

Moreover, the personal investment portfolio should be incorporated with an updating system which is capable of providing an updated security quote for all the tradable securities of the personal investment portfolio. In other words, the user should be able to view the updated security quote before planning the trade order.

In the step (2), the cash reserve is set aside from the portion of the net equity of the personal investment portfolio wherein the cash reserve can be set as an amount of cash value or a percentage of a total of the cash and all the tradable securities, so as to define the “disposable cash”. For example, the user is able to set either $6000 or 60% as the cash reserve from the net equity value of $10,000 of the personal investment portfolio. (Preferably, the percentage of the net equity should be set as the cash reserve in such a manner that the user is able to quickly determine how much he or she can access from the net equity in order to invest to the security market. If the cash reserve is to preserve cash, the disposable cash equals the account's cash balance minus the amount of cash reserve if there is no short position, or the account's cash balance minus the short account's market value, the short account's margin requirement and the cash reserve if with short positions. However, if the cash reserve is to preserve a margin account's borrowing power, where the account may carry a debt, the disposable cash equals the excess equity minus the cash reserve. Once the cash reserve is set, the user can only use the disposable cash as a capital to buy the intended security such that the user can effectively manage his or her capital to invest into the security market.

Regarding to the cash accounts, EQ means Equity, LMV means Market Value of all the securities held, and CTBD means Cash/Fund to be deposited.

In which:

Market Value=Shares×Price per Share

Equity=Cash+CTBD+LMV=Cash Balance+LMV

Disposable Cash=Equity−Cash Reserve−LMV

Unallocated EQ=Disposable Cash/EQ

Unallocated Future LMV=100%−LMV/Future (Planned) LMV

Regarding to the Margin Accounts, EQ means Equity; CMV means market Value of all the securities held in Cash account or Cash sub account of a Margin Account; LMV means market Value of all the securities held in Long Margin account; SMV means Market Value of all the securities sold short; SMR means Total Margin Requirement of all the securities sold short; LMR means Total Margin Requirement of all the securities held in Long Margin account; and CTBD means Cash/Fund to be deposited.

In which:

Market Value=Shares×Price per Share

$$- Equity = Cash + Credit - Debit + CTBD + CMV + LMV - SMV = Cash Balance + CMV + LMV - SMV$$

Excess Equity=Equity−CMV−LMR−SMR

Disposable Cash of a Margin Account:

If Cash Reserve is to preserve borrowing power,

Disposable Cash=Equity−Cash Reserve−CMV−LMR−SMR

If Cash Reserve is to preserve Cash,

Disposable Cash=Equity−Cash Reserve−CMV−LMV−SMR

Unallocated EQ=Disposable Cash/EQ

Unallocated Future LMV=100%−LMV/Future (Planned) LMV

Unallocated Future SMV=100%−SMV/Future (Planned) SMV

To simplify the formula used for Margin Account, all the securities holdings in the Cash sub account can be treated as having a margin requirement of 100% and are part of Long Margin sub Account.

It is worth to mention that all the above calculated values should be derived from the hypothetical portfolio which is copied from the real portfolio initially and should be recalculated every time the hypothetical portfolio is changed.

The step (2) further comprises a sub-step of:

(2.1) setting aside a predetermined portion of the cash reserve to form a cash allowance; and

(2.2) providing a hypothetical portfolio based on the personal investment portfolio.

In the step (2.1), the setting of the cash allowance is to allow some flexibility for suggesting shares or units to trade. Preferably a percentage of the cash reserve can be set aside as the cash allowance. For example, when the calculated shares is equal to 99 and the specified basic unit, or the preferred trading unit, is equal to 100, the result, or the calculated shares to trade, will be equal to zero. To prevent this from happening, the cash allowance is devised to give the calculation some leeway. In other words, with the cash allowance, when calculated or suggested shares to trade is equal to zero for a buy or short sell trade, based on all the fixed specifications provided by the user, a re-calculation can be tried using additional fund from the cash allowance to check if the bare minimal basic units can be acquired. Therefore, the cash allowance is a patronage of the fund specified by the user to be invested once the amount of the trade order exceeds the specified fund, so that the user has an option to exercise the money from the cash allowance.

In the step (2.2), assuming the future net equity equals to the current one, the hypothetical portfolio asset allocation can be planned wherein both the future long and future short account's market value can be specified. Treating all the securities holdings in the Cash sub account as having a margin requirement of 100%, the following formula are used for portfolio planning:

For cash account, LMV means Market Value of all the securities held long; FLMV means Future Long Market Value; FC means Future Cash Balance; and ΔLMV means the difference between the Future and the current Long market Value.

In which:

FLMV=LMV+ΔLMV

FC=Cash Reserve+Future Disposable Cash

Future Equity=Equity=FC+FLMV

For margin account, LMV means market Value of all the securities held long; SMV means Market Value of all the securities sold short; SMR means Total Margin Requirement of all the securities sold short; LMR means Total Margin Requirement of all the securities held long; FLMV means Future Long Market Value; FSMV means Future Short Market Value; FSMR % means the Short Margin Requirement to be used for planning; FLMR % means the Long Margin Requirement to be used for planning; FC means Future Cash Balance; ΔLMV means the difference between the Future and the current Long Market Value; and ΔSMV means the difference between the Future and the current Short Market Value. It is worth to mention that all the securities held long in the cash sub account of a margin account are treated as having a margin requirement of 100%.

In which:

FLMV=LMV+ΔLMV

FSMV=SMV+ΔSMV

Future Equity=Equity=FC+FLMV−FSMV

Future Equity≧LMR+ΔLMV×FLMR %+SMR+ΔSMV×FSMR %

If all the current long positions are to be ignored:

Future Equity≧FLMV×FLMR %+SMR+ΔSMV×FSMR %

If all the current short positions are to be ignored:

Future Equity≧LMR+ΔLMV×FLMR %+FSMV×FSMR %

if both the current long and short positions are to be ignored:

Future Equity≧FLMV×FLMR %+FSMV×FSMR %

If reserve is not to reserve borrowing power but actual cash:

FLMR %=100% and LMR=LMV

Future Equity≧LMV+ΔLMV+SMR+ΔSMV×FSMR %

For a brokerage Cash Account, all the short account and its related data are set to 0 and all the margin requirements are set to 100%. For a brokerage Cash Account, all the short account and its related data are set to 0 and all the margin requirements are set to 100%.

The planned future long and short market values can later be used as part of trade specification to help the user achieve his or her ideal portfolio allocation. In this case, if so to choose by the user, the amount of the dynamically calculated disposable cash can be applied as the final constraint that a planned trade should not exceed.

In the step (2.2), before placing the trade order, the hypothetical portfolio is created from the personal investment portfolio wherein the data in the personal investment portfolio will be temporary copied to the hypothetical portfolio. Therefore, the calculation will be performed and shown in the further hypothetical portfolio instead of in the personal investment portfolio. In the hypothetical portfolio, the stocks are defined in a long position for owning security outright or a short position for selling security not actually owned in anticipation of price drop. A long market value is a market value in the long position and a short market value is a market value in the short position. It is worth to mention that the data changed in the hypothetical portfolio will not affect the original data setting of the personal investment portfolio. In other words, the data in the personal investment portfolio will be saved unless the user intentionally changes the information in the personal investment portfolio directly.

It is worth to mention that when the user wants to either maintain in short positions in the future or plan to establish short positions, either the Future Long Market Value or Future Short Market Value is needed to be specified in term or either a fixed amount or a percentage of the net equity.

In the step (3), once the hypothetical portfolio allocation is planned and the hypothetical portfolio is set, the user is able to input the trade order into a hypothetical trade list for calculation. In the trade order, the name or the trading symbol of the intended stock must be specified. Moreover, the trade type of the security, such as sell, short sell, buy, or short cover, should be specified. If the trade type of the security is not specified, the hypothetical portfolio will set the trade type as a default type. According to the default type, when the user selects to trade the security that is already set in the hypothetical portfolio as a long position, the security is assumed to be sold from the long position. When the user selects to trade the security that is already set in the hypothetical portfolio as a short position, the security is assumed to be covered or bought and returned back to the securities firm. If a brand new security is selected which does not exist in the hypothetical portfolio, the assumption is to purchase the security for a long position. If multiple brand new tradable securities are selected which do not exist in the hypothetical portfolio, the assumption is to purchase the securities outright with the disposable cash invested equally among them.

The user will have options to buy and sell the securities in different ways. For example, the user is able to use the cash from the disposable cash to buy the intended securities. The user is also able to sell the securities in the personal investment portfolio in order to buy the intended securities. In other words, the user can have an option of specifying how much money, how many shares, what percentage of disposable cash, what percentage of future equity, what percentage of future long market value, what percentage of future short market value, or what percentage of buying power or day trading buying power the user wants to trade. The buying power is the purchasing power which can be used to acquire additional long or short position and the day trading buying power is the purchasing power of day-traders to open new positions.

Stocks are commonly traded in “lots” wherein each lot equals to 100 shares. Options are commonly traded in “contracts”. For example, for stock options, each contract generally covers 100 shares of the underlying security. Buying or selling mutual fund, dollar amount or shares are acceptable. To cover different trading sizes, the term “basic unit” is adopted in the embodiment. Users can freely specify their preferred “basic unit” size. During calculations, the basic unit can be treated as the “unit size” and/or the minimum size of the security that the user plans to trade.

The user is able to input the percentage of the disposable cash to buy the intended security wherein the hypothetical portfolio will calculate the number of shares of the intended security can be traded within the percentage of the disposable cash. In other words, the quantity of each of the intended securities can be expressed in form of percentage of the disposable cash.

When calculating the number of shares to trade, it must be a multiple of the specified basic unit by rounding down. Preferably, for not exceeding the user's purchasing power, rounding down the number of shares is more appropriated for a buy order. However, for selling purpose, rounding up the number of shares is also a proper assumption, as long as it does not exceed the current position and is selected by the user.

When the user specifies the shares or units of the security, the hypothetical transaction table will automatically calculate an estimated cost for buy or proceeds for sale. When the percentage of current share is specified, the hypothetical transaction table will calculate the number of shares or units whether is a multiple of specified basic unit lot size or not. If the share or unit of the security is a multiple of specified basic unit, the hypothetical transaction table will calculate an estimated cost for buy or proceeds for sale. If not, the share or unit of the security will be rounded down to the multiple of specified basic unit lot size.

While the amount of disposable cash can be used as the maximum amount each trade can spend, however, when a fixed amount of fund or a fixed number of shares/units has been specified, the restriction of not exceeding the amount of disposable cash at any one moment may be lifted, if so to choose by the user. If this is the case, the value of the disposable cash may become negative which indicates if such a trade is carried out, the account will need to be funded immediately.

When the user intends to sell the security either from the personal investment portfolio or the hypothetical portfolio the hypothetical transaction table will calculate the value of the security after selling at a specified limit price or the predetermined market price and automatically add the sales proceeds into the hypothetical net equity, of the hypothetical portfolio to split into the cash reserve and the disposable cash.

In the step (3), the method of evaluating security trading capacity of the present invention further comprises a step of:

(3.1) allowing the cash allowance from being exercised.

When the value of the intended security exceeds the amount of the disposable cash, the user has an option to round down the share of the intended security in order to maintain the capital within the disposable cash. Otherwise, the user can round up the share of the intended security wherein the difference of the values between the disposable cash and the intended security will be taken from the cash allowance. In other words, when the cost of the trade order exceeds the disposable cash, the cash allowance must be permitted by the user to compensate a difference of values between the disposable cash and the trade cost.

It is worth to mention that the amount of cash allowance can be selectively adjusted in the step (3.1) to fit for the need for providing a flexibility of the calculation.

In the step (4), the security balance including the estimated cost for buy and/or proceeds for sale of the stocks will be shown in a spreadsheet format in the hypothetical transaction table, and the end result is updated to the hypothetical portfolio, which was copied from the user's current portfolio, so that the user is able to review the investment plan from the hypothetical portfolio. Moreover, the user can selectively adjust the trade order anytime in the hypothetical transaction table and hypothetical portfolio so as to seek for the suitable investment plan.

After the estimated costs for buys and/or proceeds from sales of the securities are shown in the hypothetical transaction table, the hypothetical portfolio will be preferred to be updated with the market prices of the selected securities in such a manner that the hypothetical portfolio will be automatically re-calculated to give a most updated and accurate estimation for the user. Therefore, the user is able to evaluate the trade order in the step (5) to select the optimum investment plan before the trade order is placed in the real securities market. It is worth to mention that the user is able to modify the trade order anytime in the hypothetical transaction table to adapt the volatile stock market and the securities markets.

After trading the securities, the information will be automatically sent back to the personal investment portfolio to update the market values equity and cash balance thereof.

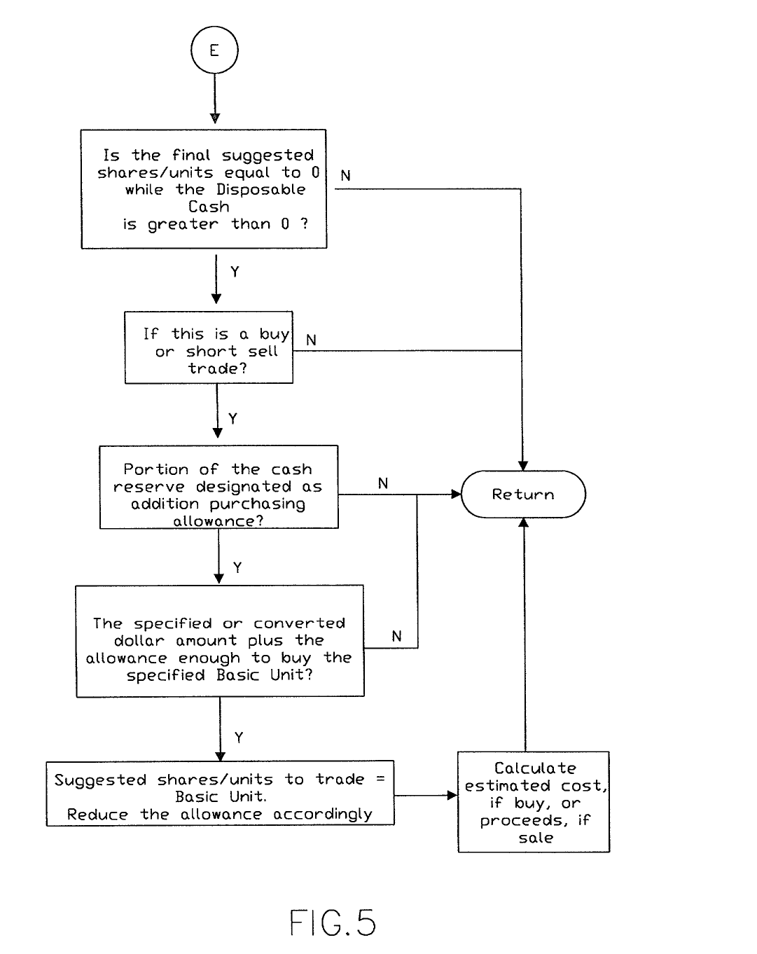

Referring to FIG. 5, a second embodiment of the present invention illustrates an alternative mode of the first embodiment, wherein the user is able to update the market value of the personal investment portfolio anytime during the entire process. It is specifically designed for a heavy-trader that he or she can input trade orders while the hypothetical portfolio and hypothetical trade list are being updated.

According to the preferred embodiment, the method of evaluating security trading capacity in the step (1) further comprises a step of:

(1.1) updating the market value of the personal investment portfolio.

In step the (1.1), in order to get equity quotes or the updated market prices for all the tradable securities of the personal investment portfolio, the personal investment portfolio is capable of linking to a source of information through electronic communication system, such as a website from Internet. The personal investment portfolio can be updated in real time or periodically such as 15 minutes. In other words, the market value of the personal investment portfolio will be updated either in real time or in a period of time preset by the user. Alternatively, the user is able to manually input the security quote anytime in order to update the market value of the personal investment portfolio.

Preferably, the personal investment portfolio should be either automatically or manually updated when the user initially starts to access the personal investment portfolio in such a manner that the user is able to analyze the updated information with respect to the securities markets. Otherwise, the updating step can also be performed at the time before the user places the trade order to give an accurate market price of the trade order.

What is claimed is:

1. A method of evaluating security trading capacity, comprising the steps of:
(a) providing an investment portfolio which is an electronic file having a predetermined market value;
(b) setting a portion of an equity to form a cash reserve from said investment portfolio, wherein said cash reserve serves as a cash portion of a future asset allocation;
(c) inputting a trade order of a predetermined amount, wherein said trade order includes at least a security to be traded and a trading price when either a fixed price is desired or a price quote is unable to be retrieved automatically;
(d) producing a security balance by computing said trade order according to either a predetermined quantity or an amount of fund to be committed; and
(e) evaluating a cost of said trade order with respect to a disposable cash which is a value difference between said equity and said cash reserve.

2. The method, as recited in claim 1, wherein said equity of said investment portfolio includes a predetermined amount of cash and one or more tradable securities to be traded in said trade order, wherein said equity of said investment portfolio is calculated by summing of a value of cash value, debt, credit, and a value of all said tradable securities and then subtracting a value of short holdings.

3. The method, as recited in claim 2, wherein said value of each of said tradable securities is determined by multiplying shares/units of said respective tradable security with a market price.

4. The method, as recited in claim 3, further comprising a step of:
(f) providing an updated security quote for each of said tradable securities of said personal investment portfolio, thereby a user is able to view said updated security quote before planning said trade order.

5. The method, as recited in claim 2, wherein, in the step (b), said cash reserve is selectively set as an amount of said value of cash and a percentage of said equity so as to define said disposable cash which is an calculated amount automatically determined.

6. The method, as recited in claim 5, wherein when said cash reserve is to preserve cash, said disposable cash equals a cash balance of said investment portfolio minus said cash reserve while there is no short position, wherein once said cash reserve is set, only said disposable cash is able to be used as a capital to buy said intended security.

7. The method, as recited in claim 5, wherein when said cash reserve is to preserve cash, said disposable cash equals a cash balance of said investment portfolio minus cash reserve, said market value of a long account, and a margin requirement of said short account while there are short positions, wherein once said cash reserve is set, only said disposable cash is able to be used as a capital to buy said intended security.

8. The method, as recited in claim 2, wherein, in the step (b), said cash reserve also serves a conservation of a borrowing power when a borrowing is allowed for a more conservative strategy when investing aggressively.

9. The method as recited in claim 8, wherein when said cash reserve is to preserve said borrowing power of a margin account, said disposable cash equals an excess equity minus said cash reserve, wherein once said cash reserve is set, only said disposable cash is able to be used as a capital to buy said intended security.

10. The method, as recited in claim 1, after the step (b) and before the step (c), further comprising a step of:
(b.1) setting aside a predetermined portion of said cash reserve to form a cash allowance.

11. The method, as recited in claim 10, wherein, in the step (b.1), said cash allowance is a patronage of said disposable cash when said amount of said trade order exceeds said disposable cash.

12. The method, as recited in claim 1, after the step (b) and before the step (c), further comprising a step of:
(b.2) providing a hypothetical portfolio based on said investment portfolio, wherein said disposable cash is calculated based on said hypothetical portfolio.

13. The method, as recited in claim 12, wherein, in the step (b.2), said hypothetical portfolio is created from said investment portfolio by temporary copying data in said investment portfolio to said hypothetical portfolio, so that a calculation is performed and shown in said hypothetical portfolio instead of in said investment portfolio and any changes of said data copied in said hypothetical portfolio do not affect said data in said investment portfolio.

14. The method, as recited in claim 13, wherein once said hypothetical portfolio is set, said trade order is able to be inputted into a hypothetical trade list of said hypothetical portfolio for calculation.

15. The method, as recited in claim 14, wherein when a trade type of said security is not specified as sell, short sell, buy or short cover, said hypothetical portfolio sets said trade type as a default type.

16. The method, as recited in claim 14, wherein when said security is set in said hypothetical portfolio as a long position, said security is assumed to be sold from said long position, and when said security that is already set in said hypothetical portfolio as a short position, said security is assumed to be covered and returned back to said security firm.

17. The method, as recited in claim 14, wherein said trade order is inputted by inputting a percentage of said disposable cash to buy said security to be traded wherein said hypothetical portfolio calculates a number of shares of said security to be traded within said percentage of said disposable cash.

18. The method, as recited in claim 17, wherein the step (b.2) further comprises a step of calculating an estimated cost for buying and an estimated cost for proceeding for sale when said shares of said security to be traded is specified.

19. The method, as recited in claim 14, wherein when said security to be traded is intent to sell, said hypothetical portfolio calculates said value of said security after selling at a predetermined price as a sale of said security and automatically adds said sale of said security into said equity of said hypothetical portfolio to split into said cash reserve and said disposable cash.

20. The method, as recited in claim 11, wherein the step (c) further comprises a step of:
(c.1) allowing said cash allowance from being exercised.

21. The method, as recited in claim 20, wherein the step (c.1) further comprises the steps of:
(c.1.1) rounding down shares of said security to be traded in order to maintain a capital thereof within said disposable cash when a value of said security to be traded exceeds said amount of said disposable cash.

22. The method, as recited in claim 20, wherein the step (c.1) further comprises the steps of:
(c.1.2) rounding up shares of said security to be traded by compensating a difference of values between said disposable cash and said security to be traded from said cash allowance.

23. The method, as recited in claim 11, after the step (b) and before the step (c), further comprising a step of:
(b.2) providing a hypothetical portfolio based on said investment portfolio.

24. The method, as recited in claim 23, wherein, in the step (b.2), said hypothetical portfolio is created from said investment portfolio by temporary copying data in said investment portfolio to said hypothetical portfolio, so that a calculation is performed and shown in said hypothetical portfolio instead of in said investment portfolio and any changes of said data copied in said hypothetical portfolio do not affect said data in said investment portfolio.

25. The method, as recited in claim 24, wherein once said hypothetical portfolio is set, said trade order is able to be inputted into a hypothetical trade list of said hypothetical portfolio for calculation.

26. The method, as recited in claim 25, wherein when a trade type of said security is not specified as sell, short sell, buy or short cover, said hypothetical portfolio sets said trade type as a default type.

27. The method, as recited in claim 25, wherein when said security is set in said hypothetical portfolio as a long position, said security is assumed to be sold from said long position, and when said security that is already set in said hypothetical portfolio as a short position, said security is assumed to be covered and returned back to said security firm.

28. The method, as recited in claim 25, wherein said trade order is inputted by inputting a percentage of said disposable cash to buy said security to be traded wherein said hypothetical portfolio calculates a number of shares of said security to be traded within said percentage of said disposable cash.

29. The method, as recited in claim 28, wherein the step (b.2) further comprises a step of calculating an estimated cost for buying and an estimated cost for proceeding for sale when said shares of said security to be traded is specified.

30. The method, as recited in claim 25, wherein when said security to be traded is intent to sell, said hypothetical portfolio calculates said value of said security after selling at a predetermined price as a sale of said security and automatically adds said sale of said security into said equity of said hypothetical portfolio to split into said cash reserve and said disposable cash.

31. The method, as recited in claim 25, wherein the step (c) further comprises a step of:
(c.1) allowing said cash allowance from being exercised.

32. The method, as recited in claim 31, wherein the step (c.1) further comprises the steps of:
(c.1.1) rounding down shares of said security to be traded in order to maintain a capital thereof within said disposable cash when a value of said security to be traded exceeds said amount of said disposable cash.

33. The method, as recited in claim 31, wherein the step (c.1) further comprises the steps of:
(c.1.2) rounding up shares of said security to be traded by compensating a difference of values between said disposable cash and said security to be traded from said cash allowance.

34. The method, as recited in claim 25, wherein in the step (d), said security balance is shown in a spreadsheet format in a hypothetical transaction table and an end result is updated to said hypothetical portfolio, so that an investment plan is able to be reviewed from said hypothetical portfolio.

35. The method, as recited in claim 14, after the step (e), further comprising a step of:
(f) updating a market price of said security to be traded in such a manner that said hypothetical portfolio automatically re-calculates to give a most updated and accurate estimation of said cost for said security to be trade; and
(g) sending back a trading information of said security after being to said investment portfolio to update a market value of said security traded, said equity and said cash balance of said investment portfolio.

36. The method, as recited in claim 25, after the step (e), further comprising a step of:
(f) updating a market price of said security to be traded in such a manner that said hypothetical portfolio automatically re-calculates to give a most updated and accurate estimation of said cost for said security to be traded; and
(g) sending back a trading information of said security after being to said investment portfolio to update a market value of said security traded, said equity and said cash balance of said investment portfolio.

37. The method, as recited in claim 34, after the step (e), further comprising a step of:
(f) updating a market price of said security to be traded in such a manner that said hypothetical portfolio automatically re-calculates to give a most updated and accurate estimation of said cost for said security to be traded; and
(g) sending back a trading information of said security after being to said investment portfolio to update a market value of said security traded, said equity and said cash balance of said investment portfolio.

38. The method, as recited in claim 1, further comprising a step of:
updating a market price of said security of said investment portfolio any time during said method of evaluating security trading capacity.

39. The method, as recited in claim 38, wherein in order to obtain said updated market price for each of said tradable securities of said investment portfolio, said investment portfolio is linked to a source of information through electronic communication system.

40. The method, as recited in claim 14, further comprising a step of:
updating a market price of said security of said investment portfolio any time during said method of evaluating security trading capacity.

41. The method, as recited in claim 40, wherein in order to obtain said updated market price for each of said tradable securities of said investment portfolio, said investment portfolio is linked to a source of information through electronic communication system.

42. The method, as recited in claim 25, further comprising a step of:
updating a market price of said security of said investment portfolio any time during said method of evaluating security trading capacity.

43. The method, as recited in claim 42, wherein in order to obtain said updated market price for each of said tradable securities of said investment portfolio, said investment portfolio is linked to a source of information through electronic communication system.

44. The method, as recited in claim 1, wherein said personal investment portfolio is stored and saved in a central site for users to remotely enter through an electronic communication system.

45. The method, as recited in claim 14, wherein said personal investment portfolio is stored and saved in a central site for users to remotely enter through an electronic communication system.

46. The method, as recited in claim 25, wherein said personal investment portfolio is stored and saved in a central site for users to remotely enter through an electronic communication system.

47. The method, as recited in claim 1, wherein said investment portfolio is stored in an electronic computing device so that a user is able to access said personal investment portfolio without using any Internet service provider.

48. The method, as recited in claim 14, wherein said personal investment portfolio is stored and saved in a central site for users to remotely enter through an electronic communication system.

49. The method, as recited in claim 25, wherein said personal investment portfolio is stored and saved in a central site for users to remotely enter through an electronic communication system.

50. The method, as recited in claim 34, wherein said personal investment portfolio is stored and saved in a central site for users to remotely enter through an electronic communication system.

51. A method of evaluating security trading capacity, comprising the steps of:
(a) providing an investment portfolio which is an electronic file having a predetermined market value;
(b) inputting a trade order of a predetermined amount, wherein said trade order includes at least a security to be traded;
(c) providing an updated security quote for each of said tradable securities of said personal investment portfolio, thereby a user is able to view said updated security quote before planning said trade order.
(d) producing a security balance by computing said trade order according to either a predetermined quantity or an amount of fund to be committed; and
(e) evaluating a cost of said trade order with respect to a disposable cash.

52. The method, as recited in claim 51, wherein said disposable cash is an equity of said investment portfolio including a predetermined amount of cash and one or more tradable securities to be traded in said trade order, wherein said equity of said investment portfolio is calculated by summing of a value of cash value, debt, credit, and a value of all said tradable securities and then subtracting a value of short holdings.

53. The method, as recited in claim 52, wherein said value of each of said tradable securities is determined by multiplying shares/units of said respective tradable security with a market price.

54. A method of evaluating security trading capacity, comprising the steps of:
(a) providing an investment portfolio which is an electronic file having a predetermined market value;
(b) inputting a trade order of a predetermined amount, wherein said trade order includes at least a security to be traded;
(c) updating a market price of said security of said investment portfolio any time by linking said investment portfolio to a source of information through an electronic communication system; and
(d) evaluating a cost of said trade order.
